(19) United States
(12) Patent Application Publication
(10) Pub. No.: US 2021/0303157 A1
(43) Pub. Date: Sep. 30, 2021

(54) ELECTRONIC DEVICE, DATA STORAGE DEVICE, AND METHOD OF OPERATING THE SAME

(71) Applicant: SK hynix Inc., Icheon (KR)

(72) Inventor: Eu Joon BYUN, Icheon (KR)

(21) Appl. No.: 16/997,246

(22) Filed: Aug. 19, 2020

(30) Foreign Application Priority Data
Mar. 30, 2020 (KR) 10-2020-0038269

(51) Int. Cl. G06F 3/06

(52) U.S. Cl. CPC G06F 3/064; G06F 3/0631; G06F 3/0652; G06F 3/0683; G06F 3/0659; G06F 3/0604; G06F 3/0653

(57) ABSTRACT

An electronic device includes a plurality of data storage devices, each of the data storage devices including a master storage device and one or more slave storage device. Each of the plurality of data storage devices includes a storage configured to store data and a controller configured to control data input and output operations of the storage. The controller of the master storage device receives device information including storage capacity information from each of the one or more slave storage devices, selects at least one target storage device among the one or more slave storage devices upon triggering of a capacity control event, transmits source data read from the storage of the master storage device to the target storage device, and erases the source data from the storage of the master storage device.

### CROSS-REFERENCES TO RELATED APPLICATION

The present application claims priority under 35 U.S.C. § 119(a) to Korean Patent Application Number 10-2020-0038269, filed on Mar. 30, 2020, in the Korean Intellectual Property Office, which is incorporated herein by reference in its entirety.

### BACKGROUND

### 1. Technical Field

Various embodiments generally relate to a semiconductor integrated device, and more particularly, to an electronic device, a data storage device, and a method of operating the same.

### 2. Related Art

A data storage device may be accessed by a host device and perform input/output operations in response to requests of the host device.

As industries related to artificial intelligences and big data have developed, an amount of data an electronic device processes using the data storage device may be remarkably increased.

In order to process massive data, it may be required to increase storage capacity of the data storage device of the electronic device. Further, it may also be required to effectively manage data stored in the data storage device.

### SUMMARY

In example embodiments of the present disclosure, an electronic device may include a plurality of data storage devices, each of the data storage devices including a master storage device and one or more slave storage device. Wherein each of the plurality of data storage devices comprises a storage configured to store data and a controller configured to control input and output operations of the data with respect to the storage. Wherein the controller of the master storage device receives device information including storage capacity information from each of the one or more slave storage devices, selects at least one target storage device among the one or more slave storage devices upon triggering of a capacity control event, transmits source data read from the storage of the master storage device to the target storage device, and erases the source data from the storage of the master storage device.

In example embodiments of the present disclosure, a data storage device may include a storage configured to store data, a controller configured to control input and output operations of the data with respect to the storage. Wherein the controller comprises a storage device interface configured to receive device information including storage capacity information from one or more slave data storage devices that are coupled to the data storage device; and a capacity controller configured to select at least one target storage device among the one or more slave data storage devices accessed through the storage device interface upon triggering of a capacity control event, transmit source data read from the storage to the at least one target storage device, and erase the source data from the storage.

In example embodiments of the present disclosure, according to a method of operating a data storage device including a storage and a controller, the method comprises receiving, by the controller, device information including storage capacity information of one or more slave data storage devices that are coupled to the data storage device; selecting, by the controller, at least one target storage device among the one or more slave data storage devices upon triggering of a capacity control event; transmitting, by the controller, source data read from a storage to the target storage device; and erasing, by the controller, the source data from the storage.

### BRIEF DESCRIPTION OF THE DRAWINGS

The above and another aspects, features and advantages of the subject matter of the present disclosure will be more clearly understood from the following detailed description taken in conjunction with the accompanying drawings, in which:

FIG. 1 is a view illustrating an electronic device in accordance with an embodiment;

FIGS. 2 to 4 are views illustrating hierarchical configurations of a data storage device in accordance with embodiments;

FIG. 5 is a view illustrating a data storage device in accordance with an embodiment;

FIG. 6 is a view illustrating a controller in accordance with an embodiment;

FIG. 7 is a view illustrating a capacity controller in accordance with an embodiment; and

FIG. 8 is a flow chart illustrating a method of operating a data storage device in accordance with an embodiment.

FIG. 9 is a view illustrating a data storage system in accordance with an embodiment.

FIG. 10 and FIG. 11 are views illustrating data processing systems in accordance with embodiments.

FIG. 12 is a view illustrating a network system including a data storage device in accordance with an embodiment.

FIG. 13 is a view illustrating a nonvolatile memory device included in a data storage device in accordance with an embodiment.

### DETAILED DESCRIPTION

Various embodiments of the present disclosure will be described in greater detail with reference to the accompanying drawings. However, the embodiments of the present disclosure should not be construed as limiting the inventive concept. Although a few embodiments of the present disclosure will be shown and described, it will be appreciated by those of ordinary skill in the art that changes may be made in these embodiments without departing from the principles and spirit of the present invention.

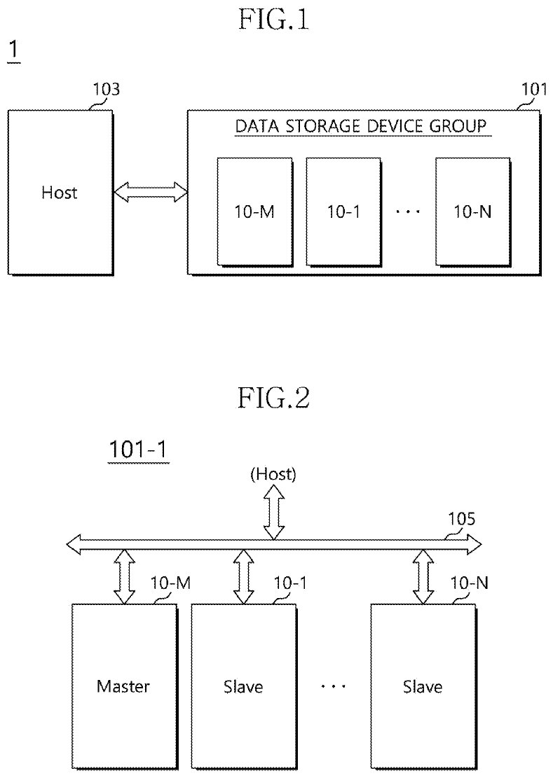

FIG. 1 is a view illustrating an electronic device 1 in accordance with an embodiment.

Referring to FIG. 1, the electronic device 1 may include a host device 103 and a data storage device group 101 configured to process data in response to a request of the host device 103.

The host device 103 may include a computing device using the data storage device group 101 as a storage medium.

The data storage device group 101 may include a plurality of data storage devices 10-M and 10-1˜10-N, M and N being positive integers greater than 1.

At least one of the plurality of data storage devices 10-M and 10-1˜10-N may be accessed by the host device 103 of the electronic device 1. The host device 103 may set any one of the data storage devices 10-M and 10-1˜10-N as a master storage device and the remaining data storage devices as slave storage devices. In FIG. 1, the storage device 10-M is set as the master storage device, and the remaining data storage devices 10-1˜10-N are set as the slave storage devices. Thus, the data storage device group 101 may include the master storage device 10-M and the slave storage devices 10-1˜10-N.

The host device 103 may transmit a read request or a write request to the master storage device 10-M to exchange data with the master storage device 10-M.

The master storage device 10-M may communicate with the slave storage devices 10-1˜10-N to receive device information of the slave storage devices 10-1˜10-N. The device information may include identification information, storage capacity information, etc. of the slave storage devices 10-1˜10-N.

In embodiments, when the data storage devices 10-M and 10-1˜10-N are electrically connected to the host device 103 and the data storage device 10-M is set as the master storage device 10-M, the slave storage devices 10-1˜10-N may be configured to transmit the device information to the master storage device 10-M.

The master storage device 10-M may select at least one of the slave storage devices 10-1˜10-N as a target storage device by triggering a capacity control event and transmit data stored in the master storage device 10-M to the target storage device.

FIGS. 2 to 4 are views illustrating hierarchical configurations of a data storage device group including the data storage devices 10-M and 10-1˜10-N in accordance with embodiments.

Referring to FIG. 2, in a data storage device group 101-1, the data storage devices 10-M and 10-1˜10-N may communicate with each other through a communication channel 105. When the host device 103 may select any one of the data storage devices 10-M and 10-1˜10-N, e.g., the data storage device 10-M, as a master storage device, the remaining storage devices 10-1˜10-N may be set as slave storage devices and recognize the master storage device 10-M as a kind of host to read or write data under the control of the master storage device 10-M. However, in this embodiment, the slave storage devices 10-1˜10-N may be directly accessed by the host device 103 through the communication channel 105.

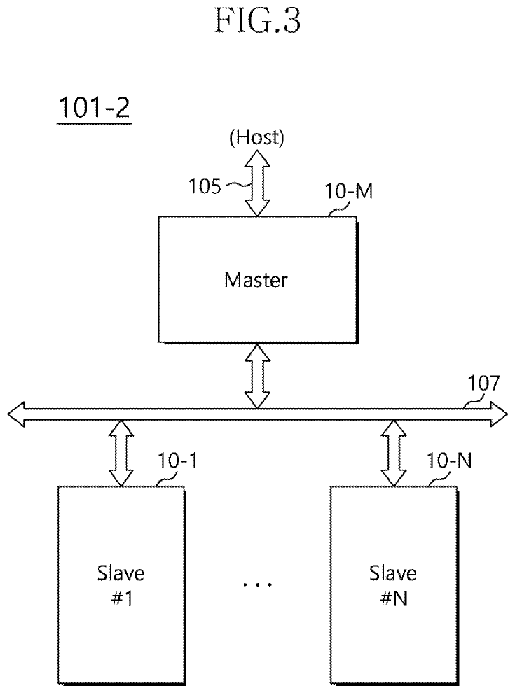

Referring to FIG. 3, in a data storage device group 101-2, the host device 103 may directly access the master storage device 10-M through a communication channel 105. The slave storage devices 10-1˜10-N may be directly accessed by the master storage device 10-M through a path 107 such as a data bus. Contrary to the embodiment illustrated in FIG. 2, the slave storage devices 10-1˜10-N may be indirectly accessed by the host device 103. In FIG. 3, each of the slave storage devices 10-1˜10-N may be controlled by the master storage device 10-M. Thus, the slave storage devices 10-1-10-N may recognize the master storage device 10-M as a kind of host. In embodiments, the slave storage devices 10-1˜10-N may be positioned in a class or at a level, which is logically lower than that of the master storage device 10-M. The slave storage devices 10-1˜10-N may be positioned in a same class or at a same level.

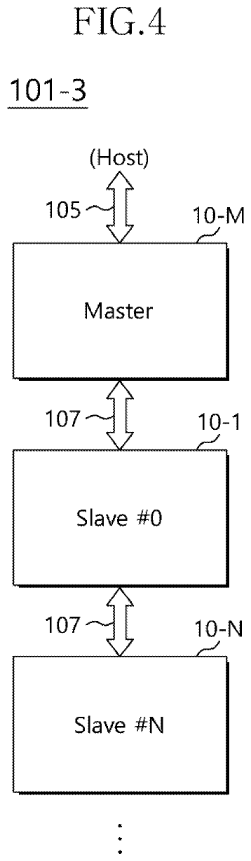

Referring to FIG. 4, in a data storage device group 101-3, the host device 103 may directly access the master storage device 10-M through a communication channel 105. One of the slave storage device 10-1˜10-N, e.g., the slave storage device 10-1, may be accessed by the master storage device 10-M through a path 107 such as a data bus. Another one of the slave storage devices 10-1-10-N, e.g., the slave storage device 10-N, may be accessed by the slave storage device 10-1 through a path 107 such as a data bus. That is, the slave storage devices 10-1˜10-N may be connected in series and hierarchically to one another. Any one of the slave storage devices 10-2-10-N may be indirectly accessed with the other slave storage devices 10-1˜10-(N−1) through a path 107 such as a data bus.

In embodiments, the slave storage devices 10-1˜10-N may have an N-level structure in which the slave storage devices 10-1-10-N are hierarchically connected to each other. That is, any one of the slave storage devices 10-1˜10-N may recognize another one of the slave storage devices 10-1˜10-N as a master or host.

In the embodiments illustrated in FIGS. 2 to 4, the master storage device 10-M may read or write data in response to a request of the host device 103. The master storage device 10-M may manage a state of a storage in the master storage device 10-M. When a capacity control event is triggered, the master storage device 10-M may transmit data stored in its storage to at least one of the slave storage devices 10-1˜10-N.

In embodiments, the capacity control event may be triggered when a garbage collection is required, when a residual capacity of the storage becomes below a first threshold value, or when the number of free blocks in the storage becomes below a second threshold value, but embodiments are not limited thereto.

When the data stored in the master storage device 10-M is transmitted to the at least one of the slave storage devices 10-1˜10-N, the master storage device 10-M may erase the transmitted data therefrom to secure a storage space therein.

The master storage device 10-M may renew mapping information with respect to the transmitted data to respond to a subsequent request of the host device 103 without an error.

In addition, in the data storage device group 101-3 illustrated in FIG. 4, when first to third data storage devices are hierarchically connected to each other, the second data storage device at a lower logical level than the first data storage device may read or write data in response to a request of the first data storage device. The second storage device may manage a state of a storage therein. When a capacity control event is triggered, the second storage device may transmit data stored in its storage to the third storage device at a lower logical level than the second data storage device.

When the data stored in the second storage device is transmitted to the third storage devices, the second storage device may erase the transmitted data therefrom to secure a storage space therein. The second storage device may renew mapping information with respect to the transmitted data to respond to a subsequent request of the first storage device without an error.

FIG. 5 is a view illustrating a data storage device 10-x in accordance with an embodiment. The data storage device 10-x of FIG. 5 may correspond to any of the data storage devices 10-1˜10-N and 10-M shown in FIGS. 1 to 4.

Referring to FIG. 5, the data storage device 10-x may include a controller 110 and a storage 120.

The controller 110 may be configured to control the storage 120 in response to a request of the host device 103 or the master storage device 10-M. For example, the controller 110 may program data in the storage 120 in response to a program (or write) request of the host device 103 or the master storage device 10-M. The controller 110 may transmit data stored in the storage 120 to the host device 103 or the master storage device 10-M in response to a read request of the host device 103 or the master storage device 10-M.

The storage 120 may be configured to store data or output stored data under the control of the controller 110. The storage 120 may include a volatile memory device or a non-volatile memory device. In embodiments, the storage 120 may include one or more of an electrically erasable and programmable ROM (EEPROM), a NAND flash memory, a NOR flash memory, a phase change RAM (PRAM), a resistive RAM (ReRAM), a ferroelectric RAM (FRAM), a spin torque transfer magnetic RAM (STT-MRAM), etc. The storage 120 may include any of a plurality of dies, a plurality of chips, a plurality of packages, etc. Further, the storage 120 may include a single-level cell (SLC) configured to store one bit of data, or a multi-level cell (MLC) configured to store more than one bit of data.

Although not depicted in drawings, a buffer memory may be provided to an interior or an exterior of the controller 110. The buffer memory may function as a temporary storage device when the data storage device 10-x may perform a sequence of operations including write and read operations with the host device 103 or the master storage device 10-M. The buffer memory may be controlled by a buffer memory management.

In embodiments, the controller 110 may include a storage device interface 201 and a capacity controller 203.

The storage device interface 201 may provide a communication channel between the data storage device 10-x and another data storage device that have a hierarchical structure substantially the same as or similar to that shown in each of FIGS. 2 to 4.

When the data storage device 10-x corresponds to any one of the data storage devices 10-1˜10-N that communicates with the master data storage device 10-M, the storage device interface 201 may provide device information of the data storage device 10-x to the master storage device 10-M recognized by the storage device interface 201. The device information may include identification (ID) information, capacity information, etc.

When the data storage device 10-x corresponds to the master data storage device 10-M, the storage device interface 201 may receive device information from one or more of the slave storage devices 10-1˜10-N that are recognized by the storage device interface 201.

As a capacity control event is triggered, the capacity controller 203 may select at least one of the slave storage devices 10-1˜10-N except the data storage device 10-x as a target storage device. The capacity controller 203 may transmit the data stored in the storage 120 to the target storage device. In embodiments, the capacity control event may be triggered when a garbage collection is required, when a residual capacity of the storage 120 becomes below a first threshold value, or when the number of free blocks in the storage 120 becomes below a second threshold value, but embodiments are not limited thereto.

When the data stored in the storage 120 is transmitted to the target storage device as the capacity control event is triggered, the capacity controller 203 may erase the transmitted data from the storage 120 to secure the capacity of the storage 120.

Further, the capacity controller 203 may renew mapping information with respect to the transmitted data.

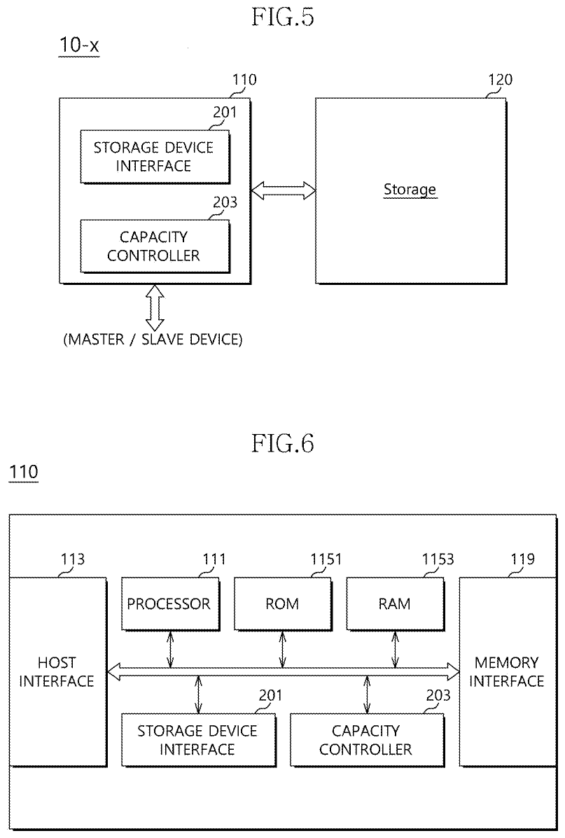

FIG. 6 is a view illustrating the controller 110 of FIG. 5 in accordance with an embodiment.

Referring to FIG. 6, the controller 110 may include a processor 111, a host interface 113, a ROM 1151, a RAM 1153, a memory interface 119, the storage device interface 201, and the capacity controller 203.

The processor 111 may provide the host interface 113, the memory interface 119, the storage device interface 201, and the capacity controller 203 with various control information used for performing a read or write operation of data with respect to the storage 120. In embodiments, the processor 111 may operate by driving a firmware provided for various operations of the data storage device 10-x. In embodiments, the processor 111 may perform functions of a flash translation layer (FTL) for performing garbage collection, address mapping, wear leveling, and the like to manage the storage 120, a function of detecting an error of data read from the storage 120 and performing error check and correction (ECC) on the detected error, and the like.

The host interface 113 may receive a command and a clock signal from the host device 103 under the control of the processor 111. The host interface 113 may provide a communication channel for controlling input/output of data. Particularly, the host interface 113 may provide a physical connection between the host device 103 and the data storage device 10-x. The host interface 113 may perform interfacing with the host device 103 according to a bus format of the host device 103. The bus format of the host device 103 may include at least one of standard interface protocols such as a secure digital, a universal serial bus (USB), a multi-media card (MMC), an embedded MMC (eMMC), a personal computer memory card international association (PCMCIA), a parallel advanced technology attachment (PATA), a serial advanced technology attachment (SATA), a small computer system interface (SCSI), a serial attached SCSI (SAS), a peripheral component interconnection (PCI), a PCI Express (PCI-E), a universal flash storage (UFS), etc.

The ROM 1151 may store program codes used for an operation of the controller 110, for example, firmware or software, code data used by the program codes, and so on.

The RAM 1153 may store data used for an operation of the controller 110 or data generated by the controller 110.

The memory interface 119 may provide a communication channel through which signals may be transmitted between the controller 110 and the storage 120. The memory interface 119 may write data in the storage 120 under the control of the processor 111. The memory interface 119 may transmit data read from the storage 120 to the host device 103 through the host interface 113.

The storage device interface 201 may provide a communication channel between the data storage device 10-x and another data storage device.

As mentioned above, each of the data storage device groups 101, 101-1, 101-2, and 101-3 may include the master storage device 10-M and the slave storage devices 10-1˜10-N. The master storage device 10-M may be directly accessed by the host device 103 through the communication channel 105 as shown in FIG. 2. In this case, the slave storage devices 10-1˜10-N may recognize the master storage device 10-M as a master or host.

Alternatively, the master storage device 10-M may be directly accessed by the host device 103 through the communication channel 105 as shown in FIG. 3. In this case, the slave storage device 10-1˜10-N may be directly accessed by the master storage device 10-M through the path 107 and recognize the master storage device 10-M as the master or host.

Further, the master storage device 10-M may be directly accessed by the host device 103 through the communication channel 105 as shown in FIG. 4. In this case, the slave storage devices 10-1-10-N may have the N-level structure in which the slave storage devices 10-1˜10-N may access each other through the path 107. That is, as shown in FIG. 4, any one of the slave storage devices 10-1-10-N may recognize another one of the slave storage device 10-1-10-N at a higher logical level than the one of the slave storage devices 10-1˜10-N as a master or host.

Referring back to FIG. 6, when the data storage device 10-x is one of the slave storage devices 10-1˜10-N that communicates with the master storage device 10-M, the storage device interface 201 may provide the master storage device 10-M recognized by the storage device interface 201 with device information including ID information, capacity information, etc. of the one of the slave storage devices 10-1˜10-N.

In addition, when the data storage device 10-x is the master storage device 10-M or one of the slave storage devices 10-1˜10-N that accesses another one of the slave storage devices 10-1˜10-N as shown in FIG. 4, the storage device interface 201 may receive device information including ID information, capacity information, etc., from one of the slave storage devices 10-1˜10-N or the other one of the slave storage devices 10-1˜10-N that is recognized by the storage device interface 201.

The capacity controller 203 may select at least one of the slave storage devices 10-1˜10-N as a target storage device by triggering the capacity control event. The capacity controller 203 may transmit data stored in the storage 120 to the target storage device. The capacity controller 203 may erase the transmitted data from the storage 120 to secure the capacity of the storage 120. The capacity controller 203 may renew mapping information with respect to the transmitted data.

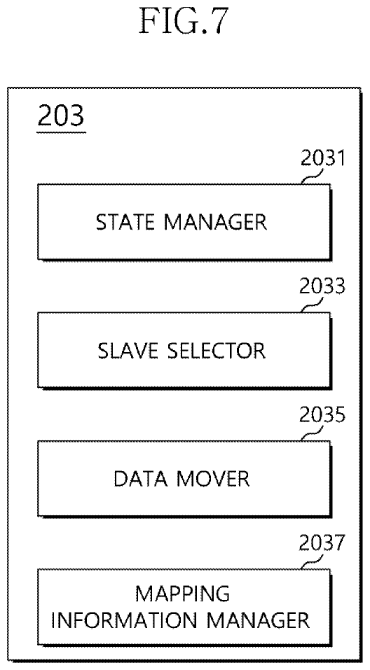

FIG. 7 is a view illustrating the capacity controller 203 of FIG. 5 in accordance with an embodiment.

Referring to FIG. 7, the capacity controller 203 may include a state manager 2031, a slave selector 2033, a data mover 2035, and a mapping information manager 2037. In an embodiment, the components in the capacity controller 203 may be implemented with one or more processors.

The state manager 2031 may be configured to determine whether the capacity control event is triggered or not in the data storage device 10-x. In embodiments, the capacity control event may be generated or triggered when a garbage collection is required, when a residual capacity of the storage 120 becomes below a first threshold value, or when the number of free blocks in the storage 120 becomes below a second threshold value, but embodiments are not limited thereto.

The slave selector 2033 may select at least one of the slave storage devices 10-1˜10-N as the target storage device when the capacity control event is triggered. In embodiments, the slave selector 2033 may select the target storage device based on a capacity to be secured in the data storage device 10-x and capacity information of the slave storage devices 10-1˜10-N. In embodiments, the capacity to be secured may be determined based on the first threshold value or the second threshold value, but embodiments are not limited thereto.

The data mover 2035 may be configured to select data (source data) to be transmitted to the target storage device. In embodiments, the storage 120 may include at least one die including at least one plane, a plane including a plurality of memory blocks, a memory block including a plurality of pages. The data mover 2035 may select a source data block based on the number of valid pages in each of the plurality of memory blocks in the storage 120 and the capacity to be secured, but embodiments are not limited thereto.

When the source data or data stored in the source data block is transmitted to the target storage device, the data mover 2035 may erase the transmitted data to secure the capacity of the storage 120.

The mapping information manager 2037 may be configured to renew mapping information with respect to the transmitted data. In embodiments, the mapping information manager 2037 may map a logical address used by the host device 103 with respect to the transmitted data, an ID number of the target storage device to which the data is transmitted, and a physical address of the target storage device in which the transmitted data is stored with each other, but embodiments are not limited thereto.

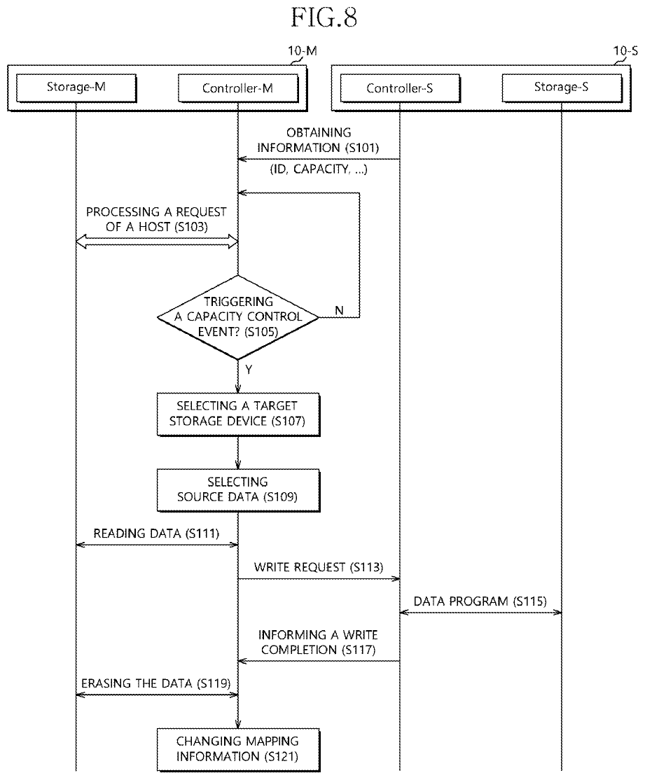

FIG. 8 is a flow chart illustrating a method of operating the data storage device group 101 of FIG. 1 in accordance with an embodiment.

When the data storage device group 101 is installed in the electronic device 1, one of the data storage devices 10-M and 10-1-10-N in the data storage device group 101 may be selected as a master storage device and the remaining data storage devices may be selected as slave storage devices. FIG. 8 shows the data storage device 10-M, selected as the master storage device, and a data storage device 10-S that is a representative of the slave storage devices 10-1˜10-N.

Referring to FIG. 8, in step S101, a master controller Controller-M of the master storage device 10-M may receive device information from a slave controller Controller-S of the slave storage device 10-S.

In step S103, the master storage device 10-M may control a master storage Storage-M to process a request of the host device 103.

During processing the request of the host device 103, in step S105, the master controller Controller-M may determine whether a condition for triggering a capacity control event is generated or not.

In embodiments, the capacity control event may be triggered when a garbage collection is required, when a residual capacity of the master storage Storage-S becomes below a first threshold value, or when the number of free blocks in the master storage Storage-S becomes below a second threshold value, but embodiments are not limited thereto.

When the capacity control event is not triggered, the master controller Controller-M may continuously process the request of the host device 103.

When the capacity control event is triggered, in step S107, the master controller Controller-M may select at least one of the slave storage devices 10-1˜10-N as a target slave storage device based on the capacity to be secured and the device information of the slave storage devices 10-1˜10-N. In FIG. 8, the slave storage device 10-S is selected as the target slave storage device.

In embodiments, the capacity to be secured may be determined based on the first threshold value or the second threshold value, but embodiments are not limited thereto.

In step S109, the master controller Controller-M may select source data or a source data block to be transmitted to the target slave storage device based on the capacity to be secured.

In step S111, the master controller Controller-M may read the source data or data stored in the source data block from the master storage Storage-M.

In step S113, the master controller Controller-M may transmit a write request including the source data or the data stored in the source data block to the slave controller Controller-S.

In step S115, the slave controller Controller-S may program the data transmitted from the master storage device 10-M in the slave storage Storage-S.

After completing the data programming, in step S117, the slave controller Storage-S may inform the master controller Controller-M of the completion of the data programming.

In step S119, the master controller Controller-M may erase the transmitted data from the master storage Storage-M to secure the capacity of the master storage Storage-M.

In step S121, the master controller Controller-M may renew or update mapping information with respect to the transmitted data. In embodiments, the master controller Controller-M may map a logical address used by the host device 103 with respect to the transmitted data, an ID number of the target slave storage device to which the data is transmitted, and a physical address of the target slave storage device in which the transmitted data is stored with each other, but embodiments are not limited thereto.

According to the embodiment, the master storage device 10-M recognizable by the host device 103 may transmit the data to the at least one slave storage device 10-S to control the capacity of the master storage device 10-M.

In another embodiment, the master storage device 10-M may move data of a slave storage device on which a capacity control operation may be performed to the master storage device 10-M or another slave storage device based on the device information received from the slave storage devices 10-1˜10-N. Thus, the capacity of the data storage devices 10-M and 10-1˜10-N may be controlled by transmitting data between the master storage device 10-M and the slave storage devices 10-1˜10-N, or between the slave storage devices 10-1˜10-N.

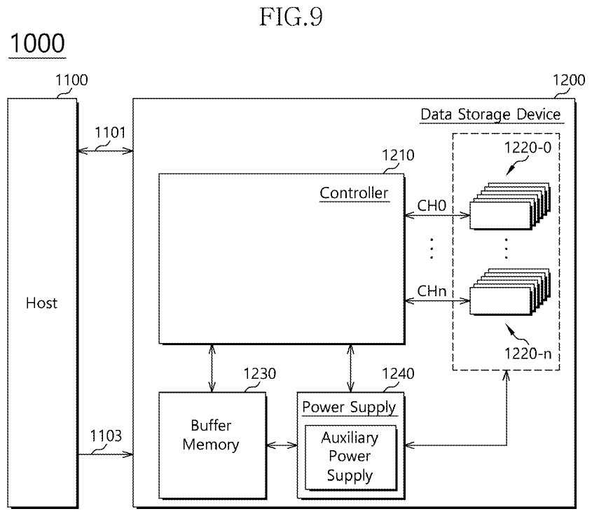

FIG. 9 is a view illustrating a data storage system 1000 in accordance with an embodiment.

Referring to FIG. 9, the data storage system 1000 may include a host device 1100 and a data storage device 1200. In an embodiment, the data storage device 1200 may be configured as a solid state drive (SSD).

The data storage device 1200 may include a controller 1210, a plurality of nonvolatile memory devices 1220-0 to 1220-n, a buffer memory device 1230, a power supply 1240, a signal connector 1101, and a power connector 1103.

The controller 1210 may control general operations of the data storage device 1200. Although not shown, the controller 1210 may include a host interface unit, a control unit, a random access memory used as a working memory, an error correction code (ECC) unit, and a memory interface unit. In an embodiment, the controller 1210 may be configured as the controller 110 shown in FIGS. 5 to 7.

The host device 1100 may exchange a signal with the data storage device 1200 through the signal connector 1101. The signal may include one or more of a command, an address, data, and so forth.

The controller 1210 may analyze and process the signal received from the host device 1100. The controller 1210 may control operations of internal function blocks of the data storage device 1200 by driving firmware or software.

The buffer memory device 1230 may temporarily store data to be stored in at least one of the nonvolatile memory devices 1220-0 to 1220-n. Further, the buffer memory device 1230 may temporarily store data read from at least one of the nonvolatile memory devices 1220-0 to 1220-n. The data temporarily stored in the buffer memory device 1230 may be transmitted to the host device 1100 or at least one of the nonvolatile memory devices 1220-0 to 1220-n according to control of the controller 1210.

The nonvolatile memory devices 1220-0 to 1220-n may be used as storage media of the data storage device 1200. The nonvolatile memory devices 1220-0 to 1220-n may be coupled with the controller 1210 through a plurality of channels CHO to CHn, respectively. One or more nonvolatile memory devices may be coupled to one channel. Nonvolatile memory devices coupled to each channel may be coupled to the same signal bus and data bus.

The power supply 1240 may provide power inputted through the power connector 1103 to the controller 1210, the nonvolatile memory devices 1220-0 to 1220-n, and the buffer memory device 1230 of the data storage device 1200. The power supply 1240 may include an auxiliary power supply. The auxiliary power supply may supply power to allow the data storage device 1200 to be normally terminated when a sudden power interruption occurs. The auxiliary power supply may include bulk-capacity capacitors sufficient to store the needed charge.

The signal connector 1101 may be implemented with one or more of various types of connectors depending on an interface scheme between the host device 1100 and the data storage device 1200.

The power connector 1103 may be implemented with one or more of various types of connectors depending on a power supply scheme of the host device 1100.

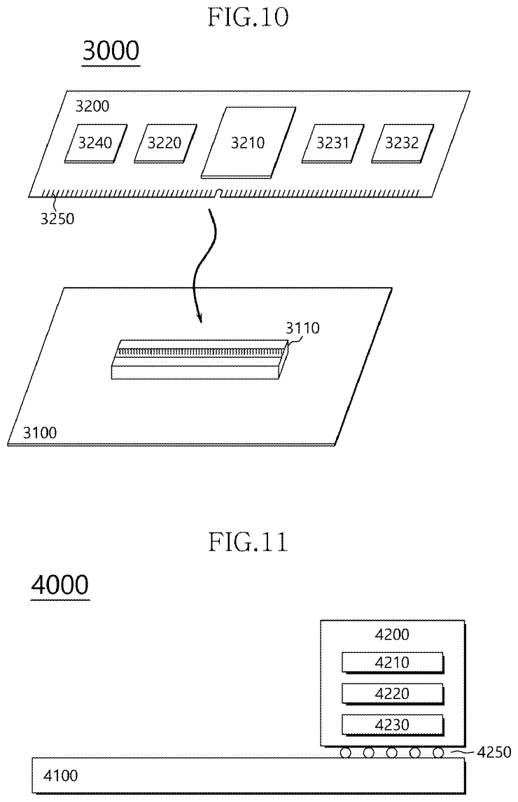

FIG. 10 is a view illustrating a data processing system 3000 in accordance with an embodiment. Referring to FIG. 10, the data processing system 3000 may include a host device 3100 and a memory system 3200.

The host device 3100 may be configured in the form of a board such as a printed circuit board. Although not shown, the host device 3100 may include internal function blocks.

The host device 3100 may further include a connection terminal 3110 such as a socket, a slot, or a connector. The memory system 3200 may be connected to the connection terminal 3110.

The memory system 3200 may be configured in the form of a board such as a printed circuit board. The memory system 3200 may be referred to as a memory module or a memory card. The memory system 3200 may include a controller 3210, a buffer memory device 3220, nonvolatile memory devices 3231 and 3232, a power management integrated circuit (PMIC) 3240, and a connection terminal 3250.

The controller 3210 may control general operations of the memory system 3200. The controller 3210 may be configured in the same manner as the controller 110 shown in FIGS. 5 to 7.

The buffer memory device 3220 may temporarily store data to be stored in the nonvolatile memory devices 3231 and 3232. Further, the buffer memory device 3220 may temporarily store data read from the nonvolatile memory devices 3231 and 3232. The data temporarily stored in the buffer memory device 3220 may be transmitted to the host device 3100 or the nonvolatile memory devices 3231 and 3232 according to control of the controller 3210.

The nonvolatile memory devices 3231 and 3232 may be used as storage media of the memory system 3200.

The PMIC 3240 may provide the power inputted through the connection terminal 3250 to the inside of the memory system 3200. The PMIC 3240 may manage the power of the memory system 3200 according to control of the controller 3210.

The connection terminal 3250 may be coupled to the connection terminal 3110 of the host device 3100. Through the connection terminal 3110 and the connection terminal 3250, signals such as commands, addresses, data, and so forth, and power may be transferred between the host device 3100 and the memory system 3200. The connection terminal 3250 may be configured to have one or more of various types depending on an interface scheme between the host device 3100 and the memory system 3200. The connection terminal 3250 may be disposed on a side of the memory system 3200, as shown in FIG. 10.

FIG. 11 is a view illustrating a data processing system 4000 in accordance with an embodiment. Referring to FIG. 11, the data processing system 4000 may include a host device 4100 and a memory system 4200.

The host device 4100 may be configured in the form of a board such as a printed circuit board. Although not shown, the host device 4100 may include internal function blocks.

The memory system 4200 may be configured in the form of a surface-mounted type package. The memory system 4200 may be mounted onto the host device 4100 through solder balls 4250. The memory system 4200 may include a controller 4210, a buffer memory device 4220, and a nonvolatile memory device 4230.

The controller 4210 may control general operations of the memory system 4200. The controller 4210 may be configured in the same manner as the controller 110 shown in FIGS. 5 to 7.

The buffer memory device 4220 may temporarily store data to be stored in the nonvolatile memory device 4230. Further, the buffer memory device 4220 may temporarily store data read from the nonvolatile memory device 4230. The data temporarily stored in the buffer memory device 4220 may be transmitted to the host device 4100 or the nonvolatile memory device 4230 according to control of the controller 4210.

The nonvolatile memory device 4230 may be used as the storage medium of the memory system 4200.

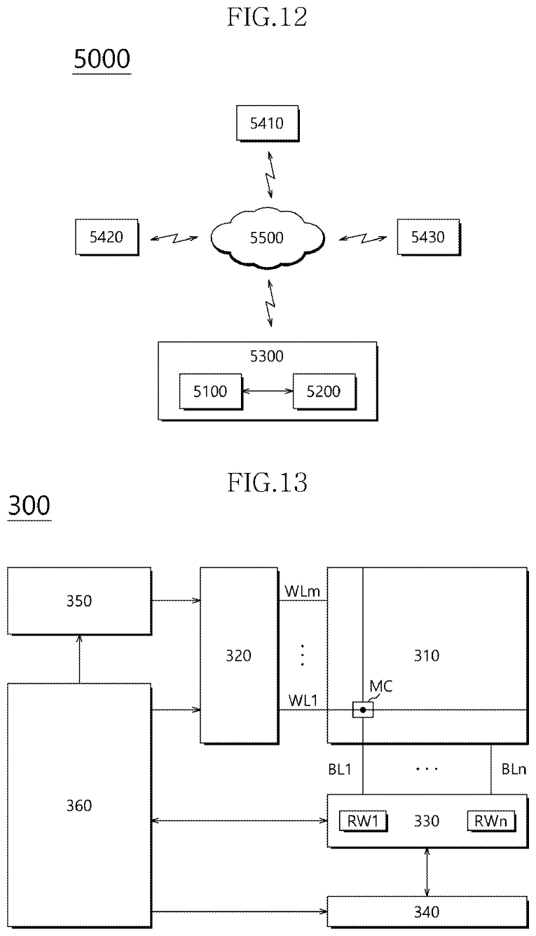

FIG. 12 is a view illustrating a network system 5000 including a data storage device in accordance with an embodiment. Referring to FIG. 12, the network system 5000 may include a server system 5300 and a plurality of client systems 5410, 5420, and 5430, which are coupled through a network 5500.

The server system 5300 may serve data in response to requests from the plurality of client systems 5410 to 5430. For example, the server system 5300 may store data provided by the plurality of client systems 5410 to 5430. For another example, the server system 5300 may provide data to the plurality of client systems 5410 to 5430.

The server system 5300 may include a host device 5100 and a memory system 5200. The memory system 5200 may be configured as the data storage device shown in FIGS. 1 to 4, the data storage device 1200 shown in FIG. 9, the memory system 3200 shown in FIG. 10, or the memory system 4200 shown in FIG. 11.

FIG. 13 is a view illustrating a nonvolatile memory device 300 included in a data storage device, such as the data storage device shown in FIGS. 1 to 4, in accordance with an embodiment. Referring to FIG. 13, the nonvolatile memory device 300 may include a memory cell array 310, a row decoder 320, a data read/write block 330, a column decoder 340, a voltage generator 350, and a control logic 360.

The memory cell array 310 may include memory cells MC which are arranged at intersections of word lines WL1 to WLm and bit lines BL1 to BLn.

The memory cell array 310 may include a three-dimensional memory array. The three-dimensional memory array may have a stacked structure arranged in a direction perpendicular to a top surface of a semiconductor substrate. Moreover, the three-dimensional memory array may include NAND strings each including a plurality of memory cells stacked in the direction perpendicular to the top surface of the semiconductor substrate.

The structure of the three-dimensional memory array is not limited to the embodiment indicated above. The memory array structure can be formed in a highly integrated manner with horizontal directionality as well as vertical directionality. In an embodiment, in the NAND strings of the three-dimensional memory array, memory cells are arranged in horizontal and vertical directions with respect to the top surface of the semiconductor substrate. The memory cells may be variously spaced to provide different degrees of integration.

The row decoder 320 may be coupled with the memory cell array 310 through the word lines WL1 to WLm. The row decoder 320 may operate according to control of the control logic 360. The row decoder 320 may decode an address provided by an external device (not shown). The row decoder 320 may select and drive the word lines WL1 to WLm based on a decoding result. For instance, the row decoder 320 may provide a word line voltage, provided by the voltage generator 350, to the word lines WL1 to WLm.

The data read/write block 330 may be coupled with the memory cell array 310 through the bit lines BL1 to BLn. The data read/write block 330 may include read/write circuits RW1 to RWn respectively corresponding to the bit lines BL1 to BLn. The data read/write block 330 may operate according to control of the control logic 360. The data read/write block 330 may operate as a write driver or a sense amplifier according to an operation mode. For example, the data read/write block 330 may operate as a write driver to store data provided by the external device in the memory cell array 310 in a write operation. For another example, the data read/write block 330 may operate as a sense amplifier to read out data from the memory cell array 310 in a read operation.

The column decoder 340 may operate according to control of the control logic 360. The column decoder 340 may decode an address provided by the external device. The column decoder 340 may couple the read/write circuits RW1 to RWn of the data read/write block 330, respectively corresponding to the bit lines BL1 to BLn, with data input/output lines or data input/output buffers, based on a decoding result.

The voltage generator 350 may generate voltages to be used in internal operations of the nonvolatile memory device 300. The voltages generated by the voltage generator 350 may be applied to the memory cells of the memory cell array 310. For example, a program voltage generated in a program operation may be applied to a word line of memory cells for which the program operation is to be performed. For another example, an erase voltage generated in an erase operation may be applied to a well area of memory cells for which the erase operation is to be performed. For still another example, a read voltage generated in a read operation may be applied to a word line of memory cells for which the read operation is to be performed.

The control logic 360 may control general operations of the nonvolatile memory device 300 based on control signals provided by the external device. For example, the control logic 360 may control operations of the nonvolatile memory device 300 such as read, write, and erase operations of the nonvolatile memory device 300.

The above described embodiments of the present disclosure are intended to illustrate and not to limit the invention. Various alternatives and equivalents thereof are possible. Nor is the invention limited to any specific type of semiconductor device. Other additions, subtractions, or modifications are obvious in view of the present disclosure and are intended to fall within the scope of the appended claims.

What is claimed is:

1. An electronic device comprising:
a plurality of data storage devices, each of the data storage devices including a master storage device and one or more slave storage devices,
wherein each of the plurality of data storage devices comprises a storage configured to store data and a controller configured to control input and output operations of the data with respect to the storage, and
wherein the controller of the master storage device receives device information including storage capacity information from each of the one or more slave storage devices, selects at least one target storage device among the one or more slave storage devices upon triggering of a capacity control event, transmits source data read from the storage of the master storage device to the target storage device, and erases the source data from the storage of the master storage device.

2. The electronic device of claim 1, wherein the capacity control event is triggered when a garbage collection is required, when a residual storage capacity of the master storage device becomes below a first threshold value, or when a number of free blocks in the master storage device become below a second threshold value.

3. The electronic device of claim 1, wherein the controller of the master storage device selects the source data based on a storage capacity to be secured by transmitting the source data, and selects the target storage device based on the storage capacity to be secured and capacity information of the one or more slave storage devices.

4. The electronic device of claim 1, wherein the device information further comprises identification (ID) information of each of the one or more slave storage devices, and the controller of the master storage device changes mapping information of the source data based on the ID information of the target storage device.

5. The electronic device of claim 1, wherein each of the one or more slave storage devices is accessed by the master storage device through a communication channel or by another slave storage device through a data bus.

6. A data storage device comprising:
a storage configured to store data; and
a controller configured to control input and output operations of the storage,
wherein the controller comprises:
a storage device interface configured to receive device information including storage capacity information from one or more slave data storage devices that are coupled to the data storage device; and
a capacity controller configured to select at least one target storage device among the one or more slave data storage devices accessed through the storage device interface upon triggering of a capacity control event, transmit source data read from the storage to the at least one target storage device, and erase the source data from the storage.

7. The data storage device of claim 6, wherein the capacity control event is triggered when a garbage collection is required, when a residual storage capacity of the storage becomes below a first threshold value, or when a number of free blocks in the storage become below a second threshold value.

8. The data storage device of claim 6, wherein the controller selects the source data based on a storage capacity to be secured by transmitting the source data, and selects the target storage device based on the storage capacity to be secured and capacity information of the one or more slave data storage devices.

9. The data storage device of claim 6, wherein the device information further comprises identification (ID) information of each of the one or more slave data storage devices, and the controller changes mapping information of the source data based on the ID information of the target storage device.

10. The data storage device of claim 6, wherein the data storage device is accessed by the one or more slave data storage devices through a communication channel or by another data storage device through a data bus.

11. A method of operating a data storage device, the data storage device including a storage and a controller, the method comprising:
receiving, by the controller, device information including storage capacity information of one or more slave data storage devices that are coupled to the data storage device;
selecting, by the controller, at least one target storage device among the one or more slave data storage devices upon triggering of a capacity control event;
transmitting, by the controller, source data read from a storage to the target storage device; and
erasing, by the controller, the source data from the storage.

12. The method of claim 11, wherein the capacity control event is triggered when a garbage collection is required, when a residual storage capacity of the storage becomes below a first threshold value, or when a number of free blocks in the storage become below a second threshold value.

13. The method of claim 11, wherein the source data is selected based on a storage capacity to be secured by transmitting the source data, and the target storage device is selected based on the storage capacity to be secured and capacity information of the one or more slave data storage devices.

14. The method of claim 11, wherein the device information further comprises identification (ID) information of each of the one or more slave data storage devices, and the controller changes mapping information of the source data based on the ID information of the target storage device.
